(19) United States
(12) Patent Application Publication
(10) Pub. No.: US 2011/0112682 A1
(43) Pub. Date: May 12, 2011

(54) MEDICINE SELECTION SUPPORT SYSTEM, MEDICINE SELECTION SUPPORT METHOD, MEDICINE DISPENSING DEVICE, AND DUMMY BODY

(76) Inventors: Yoshihiko Matsukawa, Nara (JP); Makoto Gotou, Hyogo (JP); Takanobu Tanimoto, Osaka (JP); Tohru Nakamura, Osaka (JP); Soichiro Fujioka, Osaka (JP)

(21) Appl. No.: 13/000,049

(22) PCT Filed: May 28, 2010
(86) PCT No.: PCT/JP2010/003593

§ 371 Date: Dec. 20, 2010

(30) Foreign Application Priority Data
Jun. 3, 2009 (JP) 2009-133657

(51) Int. Cl. G06F 7/00; G06T 15/00

(52) U.S. Cl. 700/214; 345/419

(57) ABSTRACT

A medicine selection support system of the invention includes an automatic dispensing device for dispensing a general medicine and a dummy body for a managed medicine based on the pharmacy information, a management terminal for reading medicine information of the managed medicine from the dummy body, and an exchange support section for supporting exchange between the managed medicine and the dummy body from the medicine information read by the terminal. With the automatic dispensing device, a dummy body corresponding to the managed medicine can be dispensed at the same timing as that of a general medicine.

### TECHNICAL FIELD

The invention relates to a technique for supporting medicine selection to prepare medicines for a patient.

### BACKGROUND ART

A system for supporting to select a medicine that corresponds to a prescription is disclosed (see, for example, Patent Document 1).

FIG. 14 is a configuration view showing a conventional medicine selection support system 91. In medicine selection support system 91 shown in

FIG. 14, firstly, a bar code reader (not shown) reads a bar code (not shown) of an injection prescription. Then, an information processing device (not shown) searches a server device (not shown) for medicine information based on the read-out bar code information. The server device receives the bar code information, searches a medicine information management table, and transmits medicine information to the information processing device. The information processing device receives the medicine information, and based on the information, it displays the medicine information that is divided as shown in FIG. 14 on screen 93. Tray 92 is partitioned corresponding to the display of the medicine information. Specifically, the medicine information is displayed in such a manner that it is divided into nine areas displayed on screen 93, and tray 92 is partitioned into nine areas corresponding to the nine areas of screen 93.

Selection of medicines is described. Firstly, a nurse looks at medicine information on screen 93, gets medicines from a medicine cabinet, and sets the medicines in each area of tray 92 corresponding to the window areas displayed on screen 93. When the nurse sets the medicines in each area of the tray, a tag reader (not shown) of tray 92 reads a tag attached On, for example, a medicine bottle. Based on information of the tag, the information processing device determines whether or not each of the medicines set on tray 92 is a correct medicine to be selected, and whether or not each of the medicines is before the expiring date. Then, the information processing device displays the determined results on screen 93.

However, a medicine cabinet for storing general medicines and a storage for storing managed medicines are separately managed. Herein, the managed medicines include separanda, medicines that need to be kept cold, or the like. Since the general medicines and the managed medicines are managed in separate places, they must be selected in different places and therefore they cannot be selected at the same time.

Furthermore, an automatic injection medicine dispensing device with which medicines such as an injection medicine are automatically selected is disclosed (see, for example, Patent Document 2). By the automatic injection medicine dispensing device, general medicines can be automatically selected, but the above-mentioned managed medicines need to be selected in a different place.

Thus, general medicines and managed medicines cannot be selected at the same timing, which may cause forgetting or mistaking in selecting managed medicines.

### [Citation List]

### [Patent Document 1] Japanese Patent Application Unexamined Publication No. 2004-70803

### [Patent Document 2] Japanese Patent Application Unexamined Publication No. 2006-109899

### SUMMARY OF THE INVENTION

The invention has an object to solve a conventional problem and to reduce the possibility of the occurrence of forgetting or mistaking in selecting managed medicines.

A medicine selection support system of the invention includes a dummy body selected based on pharmacy information; a dummy body detector for detecting medicine information from the dummy body; and an exchange support section for supporting exchange between a medicine and the dummy body based on the medicine information detected by the dummy body detector.

With this configuration, a dummy body instead of a managed medicine can be selected at the same timing as that of a general medicine. After the selection, the dummy body can be exchanged with a managed medicine reliably. This can reduce the possibility of the occurrence of forgetting or mistaking in selecting managed medicines.

Furthermore, a medicine selection support method of the invention includes automatically dispensing a general medicine and a dummy body that is a managed medicine dummy to a transporting container based on pharmacy information; and exchange supporting for supporting exchange between the dummy body and the managed medicine based on medicine information detected from the dummy body by a dummy body detector.

With this method, a dummy body instead of a managed medicine can be selected at the same timing as that of a general medicine. After the selection, the dummy body can be exchanged with a managed medicine reliably. This can reduce the possibility of the occurrence of forgetting or mistaking in selecting managed medicines.

A medicine dispensing device of the invention includes an internal dummy body; an input/output section for inputting/outputting pharmacy information including prescription information; a medicine dispensing section for selecting a medicine held therein, based on the pharmacy information; a dummy body dispensing section for selecting the dummy body as a substitute for a medicine that is not held in the medicine dispensing section based on the pharmacy information; and an exchange support section for writing medicine information of the substitute into the dummy body based on the pharmacy information.

With this configuration, even when many types of medicines are to be selected, dummy bodies instead of managed medicines can be selected at the same timing as that of general medicines. After the selection, dummy bodies can be exchanged with managed medicines reliably. This can reduce the possibility of the occurrence of forgetting or mistaking in selecting managed medicines.

A dummy body of the invention includes a memory section for recording at least medicine information and transmitting the medicine information; a dummy body main body including the memory section and having a three-dimensional shape; and a display section on which at least a part of the medicine information stored in the memory section is displayed on a surface of the three-dimensional shape.

With this configuration, dummy bodies instead of managed medicines can be selected at the same timing as that of general medicines. This can reduce the possibility of the occurrence of forgetting or mistaking in selecting managed medicines.

### BRIEF DESCRIPTION OF THE DRAWINGS

FIG. 1 is a schematic configuration view showing a medicine selection support system in accordance with a first embodiment of the invention.

FIG. 2 is a top view showing a tray in the medicine selection support system in accordance with the first embodiment of the invention.

FIG. 3 is a schematic configuration view showing an automatic dispensing device in accordance with the first embodiment of the invention.

FIG. 4 is a flowchart showing an operation of the automatic dispensing device in the medicine selection support system in accordance with the first embodiment of the invention.

FIG. 5 is a perspective view showing a dummy body in the medicine selection support system in accordance with the first embodiment of the invention.

FIG. 6 is a flowchart showing an operation of an exchange support section in the medicine selection support system in accordance with the first embodiment of the invention.

FIG. 7A is a schematic configuration view showing a dummy body in accordance with the first embodiment of the invention.

FIG. 7B is a perspective configuration view showing another dummy body in accordance with the first embodiment of the invention.

FIG. 8A is a schematic configuration view showing a dummy body in accordance with the first embodiment of the invention.

FIG. 8B is a schematic configuration view showing a dummy body in accordance with the first embodiment of the invention.

FIG. 8C is a schematic configuration view showing a dummy body in accordance with the first embodiment of the invention.

FIG. 9 is a schematic configuration view showing a medicine selection support system in accordance with a second embodiment of the invention.

FIG. 10 is a flowchart showing an operation of an exchange support section in the medicine selection support system in accordance with the second embodiment of the invention.

FIG. 11 is a front view showing a display section of the exchange support section in the medicine selection support system in accordance with the second embodiment of the invention.

FIG. 12 shows a management table of the dummy body in the medicine selection support system in accordance with the second embodiment of the invention.

FIG. 13 is a perspective view showing a dummy body in accordance with a third embodiment of the invention.

FIG. 14 is a configuration view showing a conventional medicine selection support system.

### DESCRIPTION OF THE EMBODIMENTS

Hereinafter, the embodiments of the invention are described with reference to drawings. In the following drawings, the same reference numerals are given to the same components. Therefore, the description of such components may be omitted.

### FIRST EMBODIMENT

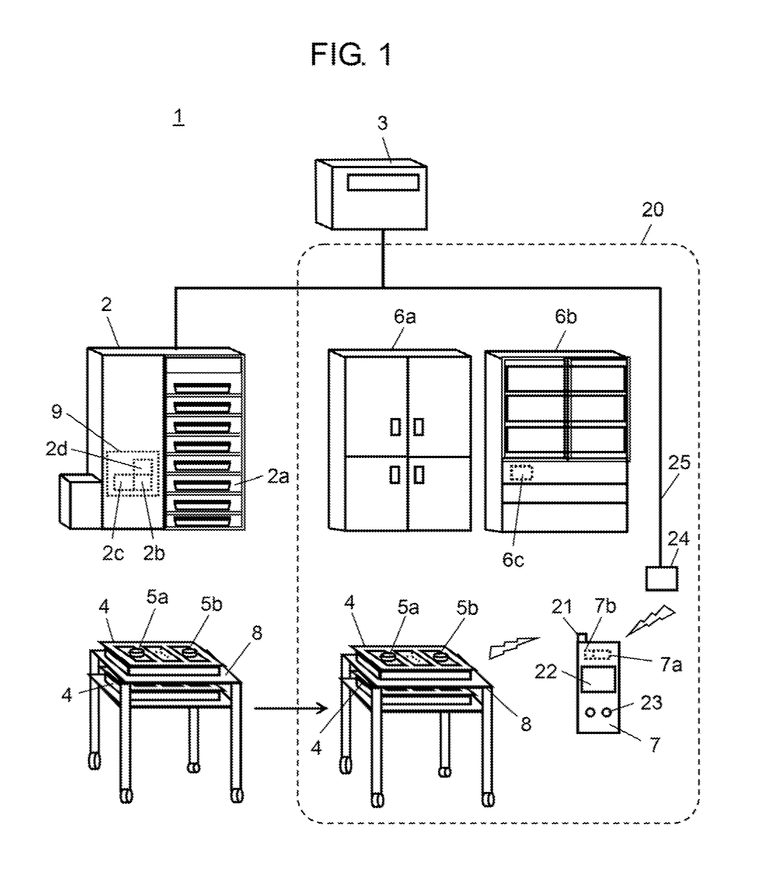

FIG. 1 is a schematic configuration view showing medicine selection support system 1 in accordance with a first embodiment of the invention. As shown in FIG. 1, medicine selection support system 1 of the first embodiment includes dummy body detector 7a for detecting medicine information from dummy bodies 5a and 5b, and exchange support section 7. Herein, dummy bodies 5a and 5b are dummy medicines selected according to pharmacy information. Furthermore, exchange support section 7 supports exchange between medicines such as managed medicines and dummy bodies 5a and 5b based on the medicine information detected by dummy body detector 7a. Furthermore, exchange support section 7 may include display section 22 for displaying medicine information and contents of exchange support.

Next, a basic operation of medicine selection support system 1 is described. Medicine selection support system 1 shown in FIG. 1 is configured to support an operation of selecting dummy bodies 5a and 5b and general medicines in tray 4 on wagon 8, and an operation of moving wagon 8 with tray 4 mounted to a different place and exchanging dummy bodies .5a and 5b with managed medicines from cold storage 6a and security storage 6b that are installed in the place so as to select managed medicines. Hereinafter, the specific operations are described.

In medicine selection support system 1 shown in FIG. 1, automatic dispensing device 2 mechanically dispenses medicines to tray 4 according to the pharmacy information extracted from medicine information management device 3. At this time, the dispensed medicines include general medicines and dummy bodies 5a and 5b. Herein, dummy bodies 5a and 5b are substitutes for managed medicines. The managed medicines include medicines that must not be lost, for example, separanda, psychotropic medicines, and the like (hereinafter, referred to as “caution medicines”), and cold-stored medicines that are required to be kept cold (hereinafter, referred to as “cold-stored medicines”). In a hospital for instance, automatic dispensing device 2 for dispensing general medicines is installed in a pharmaceutical department or a pharmacy. Managed medicines are stored separately from general medicines in room 20 that is, for example, a nurse station.

Room 20 includes cold storage 6a for storing cold-stored medicines such as an infusion bag, security storage 6b for storing caution medicines, and exchange support section 7. Herein, for example, dummy body detector 7a may be incorporated in exchange support section 7 as shown in FIG. 1.

Firstly, general medicines and dummy bodies 5a and 5b are dispensed from automatic dispensing device 2 to tray 4. An inspector such as a pharmacist makes an inspection in a state in which dummy bodies 5a and 5b are included as to whether or not the dispensed general medicines and dummy. bodies 5a and 5b are the medicines based on the pharmacy information (hereinafter, which is referred to as “formal inspection”). Thereafter, a plurality of trays 4 including dummy bodies 5a and 5b and general medicines are mounted on wagon 8 and transported to room 20. When the time of medicine administration to a patient approaches, information of the managed medicines to be exchanged with dummy bodies 5a and 5b is detected by using dummy body detector 7a of exchange support section 7. Based on the detection result, an operator such as a nurse or a pharmacist exchanges dummy bodies 5a and 5b in tray 4 with managed medicines held in cold storage 6a or security storage 6b. With this exchange, general medicines and managed medicines are selected. These medicines are set in tray 4 and put on wagon 8 and they are transported to a ward and administered to a patient.

Note here that dummy bodies 5a and 5b that have been exchanged with managed medicines are collected by, for example, a pharmacist from a vicinity of cold storage 6a and security storage 6b. Thereafter, dummy bodies 5a and 5b are disposed in a predetermined storage portion in automatic dispensing device 2 for reuse. At this time, medicine information of managed medicines and the like stored in dummy bodies 5a and 5b are deleted and reset. All of the series of such information of dummy bodies 5a and 5b including movement, collection, and reuse is accumulated together with time information such as actual movement time (movement starting time, a time period required to be moved) in medicine information management device 3.

By using such medicine selection support system 1, dummy bodies 5a and 5b and general medicines are mechanically dispensed to tray 4 by automatic dispensing device 2, and thereafter, only dummy bodies 5a and 5b can be exchanged with managed medicines. This can significantly reduce forgetting or mistaking in selecting managed medicines.

Furthermore, as shown in FIG. 1, medicine selection support system 1 has a configuration including display section 22 for displaying the medicine information detected by dummy body detector 7a. With this configuration, exchange support section 7 can appropriately grasp medicine information and display it on display section 22 rapidly. Thus, medicines to be selected are made to be clear, making it possible to further reduce forgetting or mistaking in selecting managed medicines.

Furthermore, when dummy bodies 5a and 5b as substitutes for cold-stored medicines (managed medicines) are used for selecting medicines, cold-stored medicines can be held in cold storage 6a until the time immediately before administration to a patient. In other words, the cold-stored medicines can be held in cold storage 6a so that a period of time from a time when cold-stored medicine are taken out to a time when medicines are administered to a patient or when medicines are mixed can be shortened as possible. Thus, it is possible to prevent the properties of the cold-stored medicines from being deteriorated by temperature rise of the cold-stored medicines due to the influence of room temperature. Similarly, since caution medicines (managed medicines) can be stored in security storage 6b until the time immediately before the administration to a patient, the possibility that caution medicines are lost or stolen can be reduced to the utmost.

Cold storage 6a and security storage 6b may incorporate a storage mechanism for temporarily holding dummy bodies 5a and 5b and a management mechanism of dummy bodies 5a and 5b and medicines.

Furthermore, cold storage 6a and security storage 6b may include a reset mechanism of medicine information written in dummy bodies 5a and 5b, a collecting/transporting mechanism for collecting or transporting dummy bodies 5a and 5b, and a server management mechanism for managing exchange information of dummy bodies 5a and 5b.

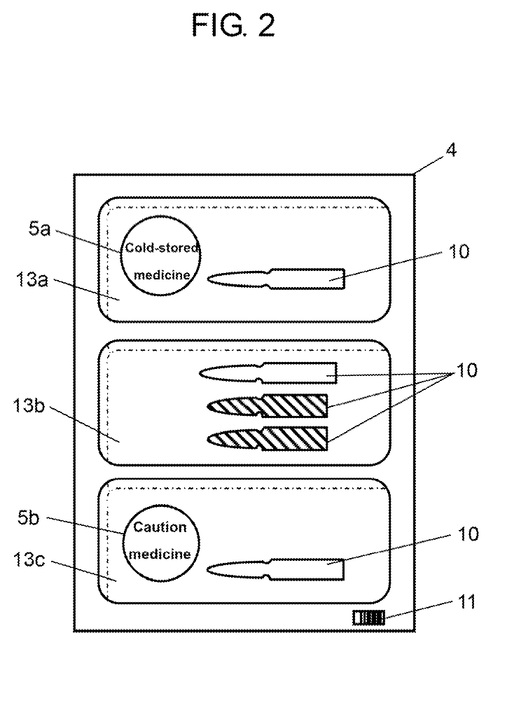

Hereinafter, selection of medicines by using medicine selection support system 1 is described in detail. FIG. 2 is a top view showing tray 4 in the medicine selection support system in accordance with the first embodiment of the invention. As shown in FIG. 2, tray 4 has bar code 11. The tray identification number and the like of tray 4 is recorded in bar code 11. Tray 4 shown in FIG. 2 is tray 4 in a state in which general medicines 10 and dummy bodies 5a and 5b are dispensed from automatic dispensing device 2. However, When medicines are selected by using medicine selection support system 1, empty tray 4 is firstly prepared in automatic dispensing device 2.

On the other hand, medicine information management device 3 prepares pharmacy information for each patient that needs medicine administration. When medicine information management device 3 receives a request to transmit pharmacy information from automatic dispensing device 2, medicine information management device 3 transmits the pharmacy information to automatic dispensing device 2. That is to say, as shown in FIG. 1, medicine information management device 3 is electrically connected to, for example, wireless receiving section 24 that exchanges information with automatic dispensing device 2 and exchange support section 7 via wired network 25, and manages medicine information of entire medicine selection support system 1.

Furthermore, medicine selection support system 1 of the first embodiment further includes medicine information management device 3 that records information that automatic dispensing device 2 dispenses dummy bodies 5a and 5b as mentioned above, and information that dummy bodies 5a and 5b are exchanged with managed medicines. Dummy body detector 7a includes exchange completion information transmitting section 7b for transmitting exchange completion information indicating that dummy bodies 5a and 5b are exchanged with managed medicines to medicine information management device 3 as shown in FIG. 1.

With this configuration, since medicine information in medicine selection support system 1 is collectively managed by medicine information management device 3, it is possible to significantly reduce the occurrence of forgetting or mistaking in selecting managed medicines.

Next, automatic dispensing device 2 dispenses medicines to tray 4 according to pharmacy information transmitted from medicine information management device 3. The pharmacy information includes information to be dispensed to each of areas 13a, 13b, and 13c of tray 4. For example, medicine names, medicine amounts, and the like, are recorded.

Furthermore, a tray identification number of tray 4 in which medicines are dispensed according to the pharmacy information is transmitted from automatic dispensing device 2 to medicine information management device 3. Then, medicine information management device 3 records the tray identification number and the pharmacy information in a state in which they are associated with each other.

With such a configuration, dummy bodies 5a and 5b and general medicines can be selected at the same timing. After the selection, dummy bodies 5a and 5b are exchanged with managed medicines. Thereby, it is possible to significantly reduce the occurrence of forgetting or mistaking in selecting managed medicines.

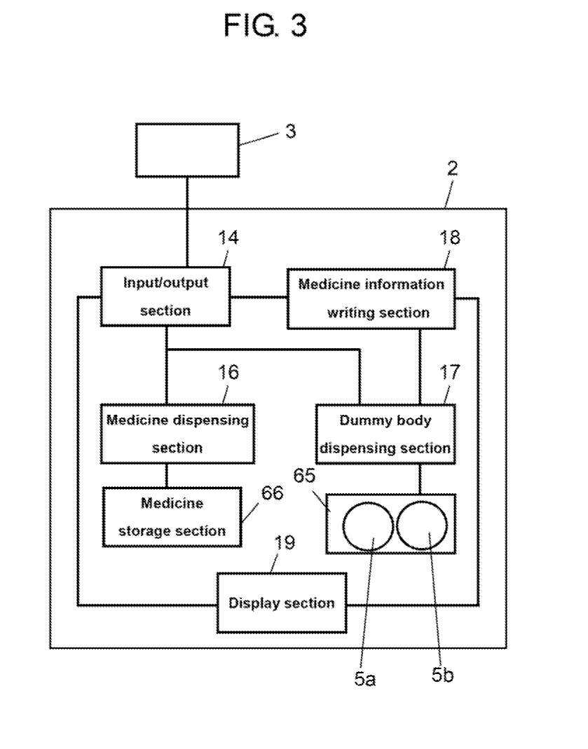

FIG. 3 is a schematic configuration view showing automatic dispensing device 2 in accordance with the first embodiment of the invention. By using automatic dispensing device 2 as shown in FIG. 3, dummy bodies 5a and 5b and general medicines are mechanically dispensed to tray 4 at one time, and thereafter, only dummy bodies 5a and 5b are exchanged with managed medicines.

As shown in FIG. 3, automatic dispensing device 2 of the first embodiment includes dummy body storage section 65 for holding dummy bodies 5a and 5b, medicine storage section 66 for holding general medicines, input/output section 14, medicine dispensing section 16 for dispensing general medicines, dummy body dispensing section 17 for dispensing dummy bodies, and medicine information writing section 18. Herein, input/output section 14 inputs and outputs pharmacy information such as prescription information. Medicine dispensing section 16 selects medicines from medicine storage section 66 according to the pharmacy information. According to the pharmacy information, dummy body dispensing section 17 selects dummy bodies 5a and 5b from dummy body storage section 65 as substitutes for medicines (managed medicines) that are not held in medicine storage section 66. Medicine information writing section 18 writes medicine information of the substitutes for dummy bodies 5a and 5b according to pharmacy information, and functions as an exchange support section.

Next, an operation of automatic dispensing device 2 is described. As shown in FIG. 3, automatic dispensing device 2 gets pharmacy information such as prescription information from medicine information management device 3 via input/output section 14. Based on the pharmacy information, automatic dispensing device 2 dispenses general medicines and the like held in automatic dispensing device 2 by medicine dispensing section 16. Furthermore, automatic dispensing device 2 dispenses dummy bodies 5a and 5b as substitutes from dummy body dispensing section 17 when the pharmacy information includes managed medicines that are not held. At this time, the information of the dispensed general medicines is recorded in recording section 2b of automatic dispensing device 2. Similarly, the information of dummy bodies 5a and 5b in which medicine information of the substitutes is written is recorded in recording section 2b of automatic dispensing device 2. Furthermore, such information can be displayed on display section 19 of automatic dispensing device 2 if necessary so that a nurse or a pharmacist can see it.

In automatic dispensing device 2, input/output section 14 receives and transmits pharmacy information such as prescription with respect to medicine information management device 3, and the like, and shares information of medicines to be selected and selected medicines. Furthermore, dummy body storage section 65 may be disposed inside dummy body dispensing section 17. Furthermore, medicine information writing section 18 may include a label recording and attaching mechanism for recording a display label of medicines dispensed from medicine dispensing section 16 or for attaching a display label to medicines or dummy bodies 5a and 5b.

With this configuration, even when many types of medicines are to be selected, dummy bodies 5a and 5b, instead of managed medicines, can be selected at the same timing as that of general medicines. After the selection, dummy bodies 5a and 5b are exchanged with managed medicines. Thereby, the possibility of the occurrence of forgetting or mistaking in selecting managed medicines can be reduced.

A medicine selection support method of the invention includes a dispensing step and an exchange-supporting step. Herein, the dispensing step automatically dispenses general medicines and dummy bodies 5a and 5b as managed medicine dummies to a transporting container (for example, tray 4) according to pharmacy information. Furthermore, in the exchange-supporting step, dummy body detector 7a supports exchange between dummy bodies 5a and 5b and managed medicines based on the medicine information detected from dummy bodies 5a and 5b.

With this method, dummy bodies 5a and 5b can be selected as managed medicine dummies at the same timing as that of the general medicines. After the selection, dummy bodies 5a and 5b can be exchanged with managed medicines reliably. Therefore, forgetting or mistaking in selecting managed medicines does not occur.

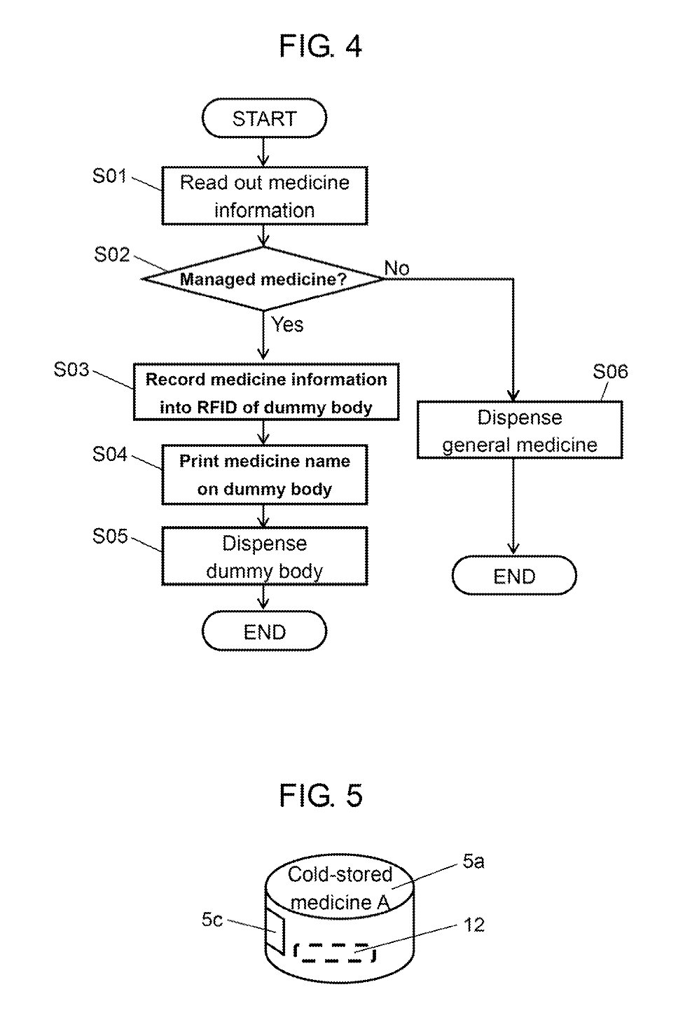

Next, an operation of dispensing of medicines, which is carried out in automatic dispensing device 2, is described in detail. FIG. 4 is a flowchart showing an operation of automatic dispensing device 2 in the medicine selection support system in accordance with the first embodiment of the invention.

As shown in FIG. 4, automatic dispensing device 2 reads out medicine information one by one from, for example, pharmacy information such as prescription of medicine information management device 3 (step S01). When a managed medicine such as cold-stored medicine A .is detected as medicine information (in the case of YES in step S02), managed medicine information is recorded in, for example, RFID tag 12 of dummy bodies 5a and 5b. That is to say, as the managed medicine information, medicine information such as a medicine name and a medicine amount of the managed medicine, patient information, tray identification number of tray 4 to which medicines are dispensed, and areas 13a, 13b, and 13c of tray 4 to which medicines are dispensed are recorded in RFID tag 12 (step S03). Thereafter, dummy body dispensing section 17 prints a medicine name, and the like, on the surfaces of dummy bodies 5a and 5b (step S04).

FIG. 5 is a perspective view showing dummy body 5a in the medicine selection support system in accordance with the first embodiment of the invention. As shown in FIG. 5, in dummy body 5a, RFID tag 12 is embedded. In RFID tag 12, for example, medicine information is recorded.

Furthermore, a medicine name is printed on the surface of dummy body 5a so that what managed medicine is substituted by dummy body 5a can be recognized at first sight. It is preferable that a medicine name is printed by any of the following manners from the viewpoint of reuse of dummy body 5a. In order to repeat printing on dummy body 5a, it is necessary that use is limited or an additional writing device is provided. Examples of such a printing device may include a printing device capable of printing in a rewritable manner using thermomagnetism, ultraviolet, or the like. Another printing method may be preparation of an additional seal. That is, a method of printing on a seal that can be attached repeatedly, and attaching the seal onto attaching section 5c on the surface of dummy body 5a may be employed.

Furthermore, by attaching a seal provided with a color or a mark on a portion other than a printing portion on the surface of dummy body 5a, or on the lower side of the printing portion in the attaching section, a type of dummy body 5a can be specified easily. In this case, for example, by attaching a red seal on dummy bodies for caution medicines, and a white seal on dummy bodies for cold-stored medicines, it is possible to visually determine the types of the dummy bodies. Thus, the possibility of mistake of selection can be further reduced.

The above-mentioned contents can be applied to the case of dummy body 5b. Similar to the above, it is possible to clarify what type of managed medicine dummy substitutes for.

After information of managed medicines is recorded in dummy bodies 5a and 5b and medicine names are printed on dummy bodies 5a and 5b, dummy bodies 5a and 5b are dispensed to tray 4 (step S05). At this time, medicine information management device 3 records that automatic dispensing device 2 dispenses dummy bodies 5a and 5b.

On the other hand, when the medicine information read out by automatic dispensing device 2 indicates not a managed medicine but general medicine 10 (in the case of NO in step S02), automatic dispensing device 2 dispenses general medicine 10 held therein to tray 4 (step S06).

By repeating operations of dispensing medicines that are carried out in automatic dispensing device 2 (steps S01 to S06), general medicine 10 or dummy bodies 5a and 5b in pharmacy information are dispensed to tray 4.

Note here that tray 4 has a plurality of areas 13a, 13b, and 13c. In tray 4, medicines for one patient are selected and divided in such a manner that medicines administered in the morning are placed in area 13a, medicines administered in the daytime are placed in area 13b, and medicines administered at night are placed in area 13c. Automatic dispensing device 2 distinguishes areas 13a, 13b, and 13c and dispenses general medicine 10 and dummy bodies 5a and 5b. Furthermore, dummy bodies 5a and 5b are dispensed for each type of managed medicine. That is to say, when pharmacy information indicates that two managed medicines of the same type are included, two dummy bodies 5a are dispensed.

Since medicines are dispensed by automatic dispensing device 2 precisely because dispensing is carried out mechanically. However, in order to select medicines more carefully, after medicines are dispensed by automatic dispensing device 2, formal inspection is carried out by an inspector.

For example, tray 4 is placed on an inspection stand (not shown) on which a formal inspection is carried out, bar code 11 is read out by a bar code detector (not shown) of the inspection stand, pharmacy information for selecting medicines in tray 4 is extracted by medicine information management device 3. The pharmacy information is displayed on a display section of the inspection stand. Then, an inspector compares the medicines on tray 4 with the medicines according to the pharmacy information for shortage or excess of medicines. At the time when the inspection is carried out, the managed medicines are not genuine managed medicines but dummy bodies 5a and 5b. However, the formal inspection determines that medicines are regarded to be correct when dummy bodies 5a and 5b are placed in the areas of the managed medicines shown by the pharmacy information.

When medicines are selected correctly and there is no problem with formal inspection, an inspector at the inspection stand informs medicine information management device 3 that the formal inspection has been completed. The information indicating that the formal inspection has been completed is recorded in medicine information management device 3.

A plurality of trays 4 that have undergone formal inspection are placed on wagon 8 and transported to room 20 as shown in FIG. 1. When the medicine administration time approaches, dummy bodies 5a and 5b and managed medicines corresponding to dummy bodies 5a and 5b are identified and exchanged with each other by using exchange support section 7.

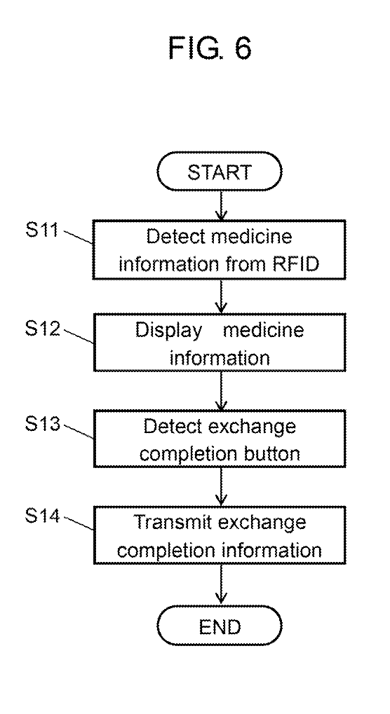

Next, exchange support that uses exchange support section 7 is described with reference to a flowchart. FIG. 6 is a flowchart showing an operation of exchange support section 7 in the medicine selection support system in accordance with the first embodiment of the invention.

Before starting the flowchart of FIG. 6, as a preparation for using exchange support section 7, authentication of an operator who can operate exchange support section 7 is carried out. Firstly, an operator allows an operator's card to approach detection section 21 of exchange support section 7.

Then, exchange support section 7 reads operator information of the operator card. Thereafter, the read-out operator information is collated with operator information that has been registered as an operator who can exchange dummy bodies 5a and 5b in medicine information management device 3. When the operator is a registered operator and medicine information of the managed medicine is registered in medicine information management device 3, it is determined that the operator is an operator who is permitted to exchange dummy bodies 5a and 5b and managed medicines. Then, exchange support section 7 works, and exchange support section 7 can be used to detect RFID tag 12 embedded in dummy bodies 5a and 5b. On the other hand, when the operator information is not registered in medicine information management device 3, it is determined that the operator is not a permitted operator, and the operator cannot detect RFID tag 12 by using exchange support section 7. Medicine information such as names of substitute managed medicines is recorded in RFID tag 12.

When preparation for using exchange support section 7 is completed, an operator who is permitted to exchange dummy bodies 5a and 5b allows dummy bodies 5a and 5b to approach detection section 21 of exchange support section 7 to detect medicine information from RFID tag 12 embedded in dummy bodies 5a and 5b (step S11). Medicine selection support system 1 displays detection result of dummy body detector 7a as medicine information on display section 22 of exchange support section 7, and supports exchange between managed medicines and dummy bodies 5a and 5b (step S12). When the medicine information of the managed medicine of dummy body 5a indicates, for example, cold-stored medicine A, cold-stored medicine A is taken out from cold storage 6a, and dummy body 5a and cold-stored medicine A are exchanged with each other. That is to say, in area 13a, instead of dummy body 5a, cold-stored medicine A will be set. Furthermore, in RFID tag 12 of dummy body 5a that has been exchanged with cold-stored medicine A, information indicating that medicine exchange has been completed is additionally recorded by exchange support section 7. That is to say, an operator uses exchange support section 7 and records information indicating that medicine exchange has been completed into RFID tag 12 of dummy body 5a in addition to the medicine information of the managed medicine (cold-stored medicine A) that has been already recorded therein. Additionally recorded dummy body 5a is temporarily contained in a storage place in the vicinity of cold storage 6a. Thereafter, a collecting and transporting person collects dummy bodies in the storage place and transports them to automatic dispensing device 2, and put them in dummy body dispensing section 17 of automatic dispensing device 2. Automatic dispensing device 2 deletes medicine information of RFID tag 12 of dummy body 5a when dummy body 5a is newly accommodated in dummy body dispensing section 17. Furthermore, when dummy body 5a is newly dispensed to tray 4 from dummy body dispensing section 17, automatic dispensing device 2 records medicine information of substitute managed medicine in RFID tag 12 of dummy body 5a, and then dispenses dummy body 5a to the corresponding area of tray 4. By sending high frequency with a larger power than the recording time to RFID tag 12, the pharmacy information about cold-stored medicine A is deleted. Dummy body 5a in which RFID tag 12 is reset is put into automatic dispensing device 2 and the like and it will be reused.

When cold storage 6a for holding cold-stored medicines has a plurality of doors (drawers), when exchange support section 7 reads dummy body 5a, by allowing exchange support section 7 and cold storage 6a to cooperate with each other so that only a door (drawer) of cold-stored medicine A to be exchanged is opened, the possibility of mistake of taking out the managed medicines can be reduced. Thus, the possibility of mistake of selecting medicines can be significantly reduced.

In this way, when exchange of dummy body 5a is completed, an operator presses exchange completion button 23. Then, exchange support section 7 detects that exchange completion button 23 is pressed (step S13), it transmits exchange completion information to medicine information management device 3 from exchange completion information transmitting section 7b (step S14). At this time, exchange support section 7 wirelessly communicates with wireless receiving section 24, so that the exchange completion information is transmitted from wireless receiving section 24 to medicine information management device 3 via wired network 25. Note here that the exchange completion information includes operator information of an operator who carried out the exchange, patient information, tray identification number, and the like, in addition to exchanged medicine information. Medicine information management device 3 records managed medicines that have already been exchanged and an operator who carried out the exchange.

Note here that exchange between dummy bodies 5a and 5b and managed medicines is carried out at times that are the same as the number of dummy bodies 5a and 5b. When the dummy body indicates a caution medicine as dummy body 5b, caution medicine is taken out of security storage 6b that holds caution medicines, and then, the caution medicine is exchanged with dummy body 5b.

Note here that the door of security storage 6b may be opened with a key, but security storage 6b may be provided with RFID detector 6c and key information of security storage 6b may be recorded in RFID tag 12 so that security storage 6b is opened by holding dummy body 5b over RFID detector 6c. In addition, security storage 6b may be provided with a person authentication function, and an operator capable of opening security storage 6b may be limited by using the person authentication function. This can enhance the security at the time of selection.

Thus, when dummy bodies 5a and 5b are used, general medicine 10 and managed medicines can be selected by automatic dispensing device 2 at one time. Consequently, mistaking in selecting managed medicines can be reduced.

That is to say, medicine selection support system 1 of the first embodiment further includes automatic dispensing device 2 for dispensing general medicine 10 and dummy bodies 5a and 5b according to pharmacy information. Automatic dispensing device 2 includes at least one of dispensing section 2a for dispensing managed medicines, recording section 2b for recording at least medicine information of managed medicine among pharmacy information into dummy bodies 5a and 5b, and dummy body detector 2c for detecting medicine information from dummy bodies 5a and 5b.

With this configuration, even when many types of medicines are to be selected, dummy bodies 5a and 5b as managed medicines can be selected at the same timing as that of general medicine 10, and dummy bodies 5a and 5b can be reliably exchanged with managed medicines after the selection. Therefore, it is possible to significantly reduce the occurrence of forgetting or mistaking in selecting managed medicines.

Furthermore, medicine selection support system 1 of the first embodiment further includes exchange support section 9 including display section 2d for displaying the medicine information detected by dummy body detector 2c.

With this configuration, since dummy bodies 5a and 5b can be reliably exchanged with managed medicines after the selection, it is possible to significantly reduce the occurrence of forgetting or mistaking in selecting managed medicines.

Note here that exchange support section 7 also has a function of deleting the information recorded in RFID tag 12 of dummy bodies 5a and 5b. In dummy bodies 5a and 5b that has been completed to be exchanged with managed medicines, by deleting medicine information in RFID tag 12 with the use of exchange support section 7, dummy bodies 5a and 5b can be initialized for reuse. Furthermore, medicine names and the like are printed on dummy bodies 5a and 5b, but by using printing ink that can be erased by irradiation with ultraviolet rays, dummy bodies 5a and 5b can be reused. Furthermore, automatic dispensing device 2 attaches a plain seal on the printed medicine names and the like, and printing is carried out on the attached seal, so that dummy bodies 5a and 5b may be reused.

That is to say, medicine selection support system 1 of the first embodiment has a configuration in which automatic dispensing device 2 has a deleting function for deleting medicine information recorded in dummy bodies 5a and 5b. With this configuration, dummy bodies can be reused as substitutes for managed medicines many times.

Furthermore, automatic dispensing device 2 may only record medicine information in RFID tag 12 of dummy body 5a without directly printing medicine names and the like on the surface of dummy body 5a. In such a case, dummy bodies 5a whose main body is red are used for caution medicines, and dummy bodies 5a whose main body is white are used for cold-stored medicines. In formal inspection, the number of caution medicines that have been dispensed in each of areas 13a, 13b, and 13c of tray 4, and the number of cold-stored medicines that have been dispensed in each of areas 13a, 13b, and 13c of tray 4 may be confirmed.

Furthermore, as shown in FIG. 5, a seal for each color corresponding to medicine information may be attached on attaching section 5c on the surface of dummy body 5a. Furthermore, on attaching section 5c, a seal on which a medicine name is printed based on the medicine information may be attached. With such a configuration, for example, a type of managed medicine substituted by dummy body 5a can be visually recognized immediately. Thus, the possibility of the occurrence of forgetting or mistaking in selecting managed medicines can be significantly reduced. Note here that after medicines are exchanged, a seal for dummy body 5a may be removed, so that it can be visually confirmed that exchange of dummy body 5a has been completed.

Furthermore, medicine selection support system 1 of the first embodiment has a configuration in which dummy bodies 5a and 5b have RFID tag 12 and substituted medicine information is recorded in RFID tag 12. Thus, by referring to information in RFID tag 12 of dummy body 5a, the possibility of the occurrence of forgetting or mistaking in selecting managed medicines can be significantly reduced. Note here that the medicine information in RFID tag 12 may be deleted by using not only automatic dispensing device 2 but also exchange support section 7.

Furthermore, other than the case in which automatic dispensing device 2 records medicine information in dummy body 5a and dispenses dummy body 5a, a case may be employed in which a plurality of dummy bodies 5a in which medicine information has already been recorded are prepared, and they are dispensed as needed. Furthermore, a configuration may be employed in which an identification number is written in dummy body 5a, and when dummy body 5a is dispensed, the identification number of dummy body 5a and information of a substituted managed medicine are associated with each other, which is recorded in medicine information management device 3. This makes it possible to exchange with managed medicines based on the medicine information of medicine information management device 3 corresponding to the identification number of the dummy body.

Furthermore, automatic dispensing device 2 dispenses medicines in tray 4 having a plurality of areas, but they may be dispensed in a tray having one area. Furthermore, they may be dispensed into, for example, a medicine bag instead of tray 4 as long as it is transporting containers.

Furthermore, identification number and the like of tray 4 is recorded in bar code 11, but by using RFID (not shown) instead of bar code 11, identification number and the like of tray 4 may be recorded in the RFID.

Note here that when the time of medicine administration to a patient approaches, dummy bodies 5a and 5b may be exchanged with managed medicines. However, when mixing operation for mixing different types of medicines on tray 4 is necessary, dummy bodies 5a and 5b may be exchanged with managed medicines at the same timing as the mixing operation. Thus, the operation efficiency can be improved.

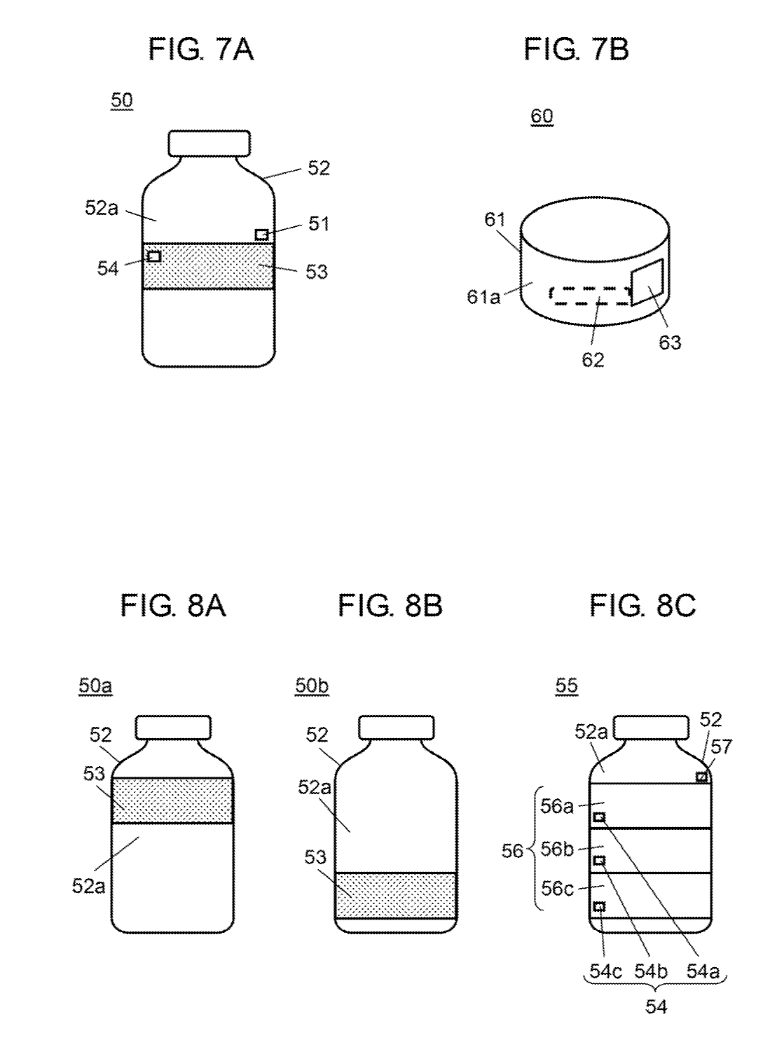

Configuration examples of dummy bodies that can be used as dummy bodies 5a and 5b in the first embodiment are shown in FIGS. 7A, 7B, 8A, 8B, and 8C. Dummy bodies 50, 50a, 50b, 55, and 60 described below are just examples that can be used as above-mentioned bodies 5a and 5b, respectively. As shown in FIG. 7A, dummy body 50 of the first embodiment includes memory section 51, dummy body main body 52 that is formed in a three-dimensional shape of a general medicine bottle, and display section 53. Herein, memory section 51 records at least medicine information, and sends this medicine information. Dummy body main body 52 is configured by molding, for example, resin materials. Then, dummy body main body 52 has memory section 51 on surface 52a thereof, or incorporates memory section 51. Display section 53 is formed-on surface 52a of dummy body main body 52 and formed of, for example, sheet-shaped transparent display materials. Then, display section 53 displays at least a part of medicine information recorded by memory section 51. Herein, for example, display section 53 displays “cold-stored medicine A.”

With this configuration, dummy bodies, instead of managed medicines such as separanda and medicines requiring cold storage, can be selected at the same timing as that of general medicines. Thus, the possibility of the occurrence of forgetting or mistaking in selecting managed medicines can be reduced.

Dummy body main body 52 of dummy body 50 shown in FIG. 7A is formed in a three-dimensional shaped medicine container that looks like a vial container. Dummy body main body 52 is made of, for example, highly medicine-resistant resin materials, which is not changed when it is brought into contact with chemicals (medicines) and the like. However, the size of dummy body is made to be the size that can be easily used in a system for treating medicines. Therefore, dummy body 50 is smaller than the size of common managed medicines.

Furthermore, a part of display section 53 may include light-emitting element 54 such as LED. In this case, for example, when the LED is composed of at least three elements, that is, red, green and blue elements, display section 53 can carry out different display corresponding to medicine information. With this configuration, depending on types of medicines according to the medicine information, colors of display section 53 of dummy body 50 can be changed. Thus, for example, medicines having high toxicity are shown in red, cold-stored medicines that need to be kept cold are shown in blue, and medicines that may be treated as separanda are shown in yellow. Thus, a person who carries out selection of medicines can recognizes the properties of managed medicines shown by dummy body 50 by colors of display section 53 at first sight.

FIG. 7B shows another dummy body 60 of the first embodiment. Dummy body 60 includes dummy body main body 61 that is made of resin material such as Teflon and ceramic fluororesin and has a cylindrical three-dimensional shape. Memory section 62 includes an RFID tag incorporated in dummy body main body 61, which is covered with and molded by, for example, resin material on the circumference thereof so as to form dummy body 60. Memory section 62 records at least medicine information, and sends the medicine information. Display section 63 is disposed on surface 61a of cylindrical shape and displays at least a part of the medicine information stored by memory section 62.

Such dummy body 60 can be used in a medicine selection system as a substitute for a managed medicine. Therefore, dummy body 60 instead of a managed medicine can be selected together with a general medicine at the same timing, thus reducing the possibility of the occurrence of forgetting or mistaking in selecting managed medicines.

FIGS. 8A, 8B, and 8C show schematic configuration views of dummy bodies 50, 50a, 50b, and 55 in accordance with the first embodiment of the invention. FIGS. 8A, 8B, and 8C are different from FIG. 7A in the position and configuration of display section 53.

FIGS. 8A and 8B are different from each other in the position of display section 53 occupied in surface 52a of dummy body main body 52 of dummy bodies 50a and 50b. FIG. 8A has display section 53 in the upper part of surface 52a, and shows, for example, dummy body 50a that substitutes for managed medicines having high toxicity. FIG. 8B has display section 53 in the lower part of surface 52a, and shows, for example, dummy body 50b that substitutes for cold-stored medicines that needs to be kept cold. In this way, by changing the position of display section 53 according to the types of managed medicines, by just looking and recognizing the position of display section 53 in dummy bodies 50a and 50b, the types of the managed medicines that are substituted by dummy bodies 50a and 50b can be recognized. Display section 56 of dummy body 55 shown in FIG. 8C has a plurality of divided areas, that is, divided areas 56a, 56b, and 56c, and can switch displays of divided areas 56a, 56b, and 56c corresponding to medicine information, respectively. For example, divided areas 56a, 56b, and 56c correspond to medicine information such that red divided area 56a shows medicines having high toxicity, blue divided area 56b shows cold-stored medicines that need to be kept cold, and yellow divided area 56c shows medicines that may be treated as separanda, sequentially from the upper part. That is to say, dummy body 55 is a substitute for a medicine having high toxicity, divided area 56a is displayed in red. Dummy body 55 is a substitute for a cold-stored medicine, divided area 56b is displayed in blue. Note here that dummy body 55 is a substitute for a cold-stored medicine having high toxicity, divided area 56a is displayed in red and divided area 56b is displayed in blue. Furthermore, as shown in FIG. 8C, the above-mentioned colors may be displayed in such a manner that display section 56 is formed of, for example, a thin sheet-like transparent display material, and light-emitting element 54 such as LED is partially included as a light source. Furthermore, on the surface of the transparent display material, pixels or a circuit for operating them may be formed so as to display characters, and the like.

With such configuration, with positions or colors of display section 56 of dummy body 55, a person who selects medicines can know the properties of managed medicines shown by dummy body 55 at first sight.

Furthermore, as shown in FIG. 8C, dummy body main body 52 may further include speaker 57. For example, small and flat speaker 57 is disposed on surface 52a of dummy body main body 52. By using speaker 57, for example, when a person touches dummy body 55, properties of the managed medicines substituted by dummy body 55 can be informed from speaker 57 via voice. Examples of methods for informing the properties of the managed medicines includes a method for issuing voice such as “the dummy substitutes for a medicine having high toxicity” and “the dummy substitutes for a managed medicine” from speaker 57. Thus, by using speaker 57, the possibility of the occurrence of forgetting or mistaking in selecting managed medicines can be further reduced.

### SECOND EMBODIMENT

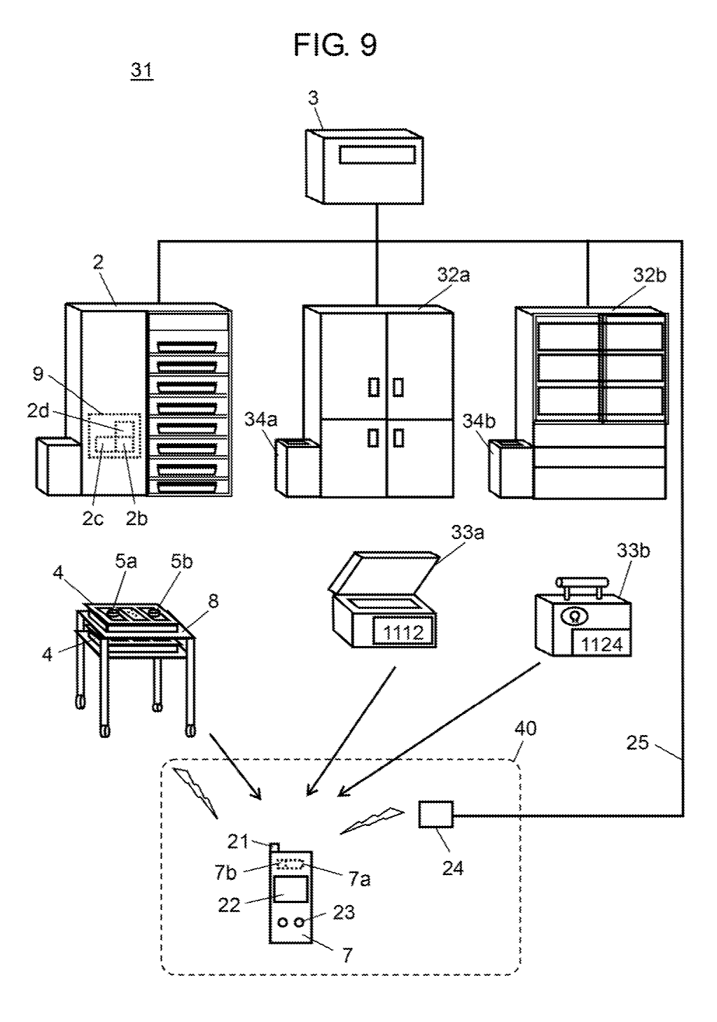

FIG. 9 is a schematic configuration view showing medicine selection support system 31 in accordance with a second embodiment of the invention. As shown in FIG. 9, medicine selection support system 31 of the second embodiment includes dummy bodies 5a and 5b, automatic dispensing device 2, mobile storage 33a, dummy body detector 7a, exchange support section 7, and display section 22. Herein, automatic dispensing device 2 dispenses general medicines and dummy bodies 5a and 5b corresponding to managed medicines according to pharmacy information. Mobile storage 33a holds managed medicines, and for example, cold-storage container 33a may be used. Dummy body detector 7a detects medicine information from dummy bodies 5a and 5b. Exchange support section 7 supports exchange between managed medicines and dummy bodies 5a and 5b based on the medicine information detected by dummy body detector 7a. Display section 22 displays storage information of mobile storage 33a from which managed medicines are to be dispensed according to the medicine information.

With this configuration, when many types of medicines are to be selected, dummy bodies 5a and 5b can be selected as managed medicine dummies at the same timing as that of general medicines. In addition, since dummy bodies 5a and 5b can be reliably exchanged with managed medicines after the selection, the occurrence of forgetting or mistaking in selecting managed medicines can be significantly reduced.

Unlike the first embodiment, the second embodiment shows medicine selection support system 31 in which, mobile storage 33a is used and thereby dummy bodies 5a and 5b can be exchanged with managed medicines In a room that is not provided with a storage such as cold storage 32a.

Medicine selection support. system 31 shown in FIG. 9 includes cold-storage container 33a as mobile storage 33a and security container 33b in addition to automatic dispensing device 2, medicine information management device 3, and cold storage 32a and security storage 32b.

Next, an operation of medicine selection support system 31 of the second embodiment is described. Firstly, general medicines and dummy bodies 5a and 5b dispensed to tray 4 by automatic dispensing device 2 are subjected to formal inspection by an inspector.

After formal inspection is carried out, based on the dummy body identification read out from dummy bodies 5a and 5b by exchange support section 7, medicine information management device 3 retrieve a moving destination of tray 4. In medicine information management device 3, places where dummy bodies 5a and 5b and managed medicines are exchanged from each other are determined and recorded for each patient. Herein, since exchanging place of tray 4 is room 40, tray 4 is placed on wagon 8 that is moved to room 40. Formal inspection is carried out a plurality of times, and then a plurality Of trays 4 are placed in the vertical direction of wagon 8.

As a place where dummy bodies 5a and 5b are exchanged with managed medicine, places determined by medicine information management device 3 are recorded. For example, a nurse station on the fifth floor is recorded when a ward of a patient is on the fifth floor, and a nurse station on the third floor is recorded when a ward of a patient is on the third floor.

Then, an operator transfers managed medicines that need to be exchanged with dummy bodies 5a and 5b from cold storage 32a and security storage 32b to cold-storage container 33a and security container 33b.

Before an Operator carries out such a transfer operation, in order to know cold-stored medicines that should be moved from cold storage 32a to room 40, the operator firstly inputs room 40 as moving destination information from input/output section 34a of cold storage 32a. Then, cold storage 32a inquires medicine information management device 3 and detects managed medicine information of managed medicines which are to be exchanged in room 40, whose dummy bodies 5a have been already dispensed, and which have not been exchanged with dummy bodies 5a. Then, the names and amounts of such managed medicines are displayed on input/output section 34a.

An operator collects cold⁻stored medicines displayed on input/output section 34a into cold-storage container 33a, and then inputs, for example, “1112” as a management number of cold-storage container 33a into input/output section 34a. Then, cold-storage container 33a and cold-stored medicines contained in cold-storage container 33a are associated with each other and they are recorded in medicine information management device 3. Note here that refrigerant is contained in cold-storage container 33a, and therefore, a cold storage environment that is the same as cold storage 32a can be made for a certain period of time.

Furthermore, in order to know caution medicines that should be moved from security storage 32b to room 40, an operator inputs room 40 as moving destination information from input/output section 34b of security storage 32b. Then, security storage 32b inquires medicine information management device 3 and detects managed medicine information of managed medicines which are to be exchanged in room 40, whose dummy bodies 5b have been are already dispensed, and which have not been exchanged with dummy body 5b. Then, the names and amounts of such managed medicines are displayed on input/output section 34b.

Furthermore, an operator collects caution medicines displayed on input/output section 34b into security container 33b, locks security container 33b, and inputs, for example, “1124” as a management number of security container 33b to input/output section 34b. Then, security container 33b and the caution medicines contained in security container 33b are associated with each other, and recorded in medicine information management device 3.

Then, an operator transports tray 4, cold-storage container 33a, and security container 33b to room 40. When the operator transports tray 4 to room 40, cold-storage container 33a and security container 33b may be transported to room 40 at one time by placing them on wagon 8 in which trays 4 are placed. Furthermore, a transporting route of security container 33b can be different from a transporting route of cold-storage container 33a and trays 4. By making the transporting routes different from each other, security at the time of transportation can be improved.

Thus, tray 4, cold-storage container 33a, and security container 33b are placed in room 40, and when the time of medicine administration to a patient approaches, dummy bodies 5a and 5b are exchanged with cold-stored medicines and caution medicines.

That is to say, in medicine selection support system 31 of the second embodiment, the managed medicines are cold-stored medicines that require temperature management and mobile storage 33a is cold-storage container 33a capable of carrying out temperature management.

With this configuration, even when managed medicines include cold-stored medicines that require temperature management, managed medicines can be selected in an appropriate cold storage environment. Thus. the occurrence of forgetting or mistaking in selecting managed medicines can be reduced significantly.

Furthermore, managed medicines are deleterious substances that require security management, mobile storage 33a is security container 33b in which security management can be carried out.

With this configuration, even when managed medicines include caution medicines such as deleterious substances that require security management, managed medicines can be selected in an appropriate security management environment. Thus, the occurrence of forgetting or mistaking in selecting managed medicines can be reduced significantly.

With the use of such medicine selection support system 31, dummy bodies 5a and 5b and general medicines corresponding to managed medicines are mechanically dispensed to tray 4 by automatic dispensing device 2. Thereby, mistaking in selecting managed medicines can be reduced.

Furthermore, with the use of cold-storage container 33a and security container 33b, temperature management of managed medicines are carried out more strictly, and strict management with detailed security can be carried out.

When such movable cold-storage container 33a and security container 33b are used, even in room 40 that is not provided with cold storage 32a and security storage 32b, dummy bodies 5a and 5b can be exchanged with managed medicines that have been transported into room 40 using cold-storage container 33a and security container 33b. Therefore even when room 40 is not provided with cold storage 32a and security storage 32b, dummy bodies 5a and 5b can be exchanged with managed medicines in a ward of a patient to whom the medicines are to be administered, or in, for example, a nurse station near a ward of a patient. This can shorten the time period from the time when the managed medicines are taken out from cold-storage container 33a and security container 33b to the time when the medicines are administered to a patient. Thus, the effect of the temperature rise of the cold-stored medicines by room temperature can be reduced, and the possibility that caution medicines are lost or stolen can be significantly reduced.

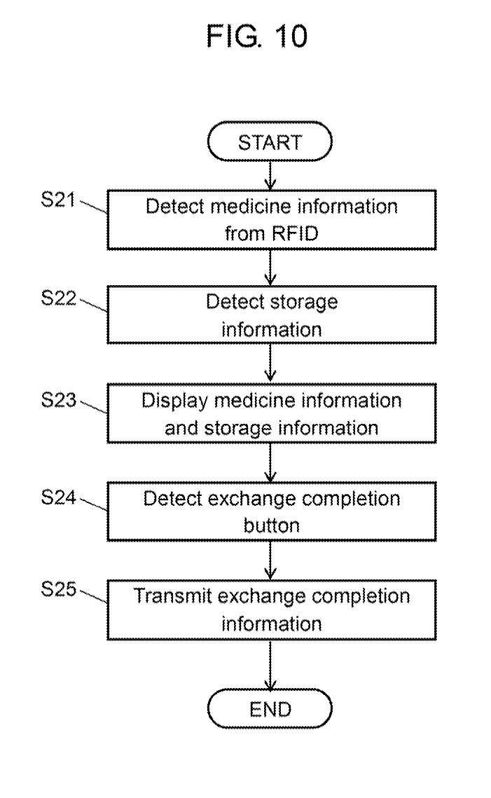

Next, exchange using exchange support section 7 is described with reference to a flowchart. FIG. 10 is a flowchart showing an operation of exchange support section 7 in medicine selection support system 31 in accordance with the second embodiment of the invention.

Firstly, as a preparation of the use of exchange support section 7, registration of an operator is carried out. By allowing operator's card to approach detection section 21 of exchange support section 7, an operator who can exchange dummy bodies 5a and 5b is registered.

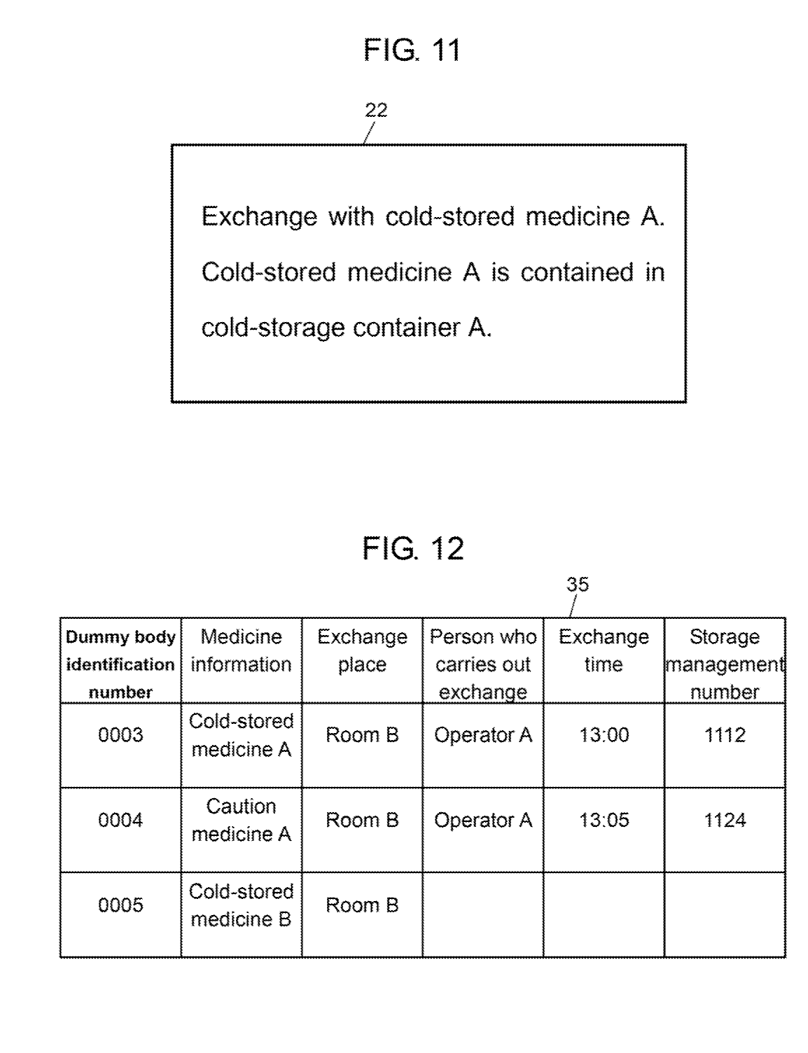

Then, by allowing detection section 21 of exchange support section 7 to approach dummy bodies 5a and 5b, medicine information is detected from RFID tag 12 embedded in dummy body 5a (step S21). Inquiry as to a place of a medicine shown by the medicine information is carried out to medicine information management device 3. Since in medicine information management device 3, management number “1121” of cold-storage container 33a that holds cold-stored medicines shown by dummy body 5a is recorded, this management number “1121” is transmitted to exchange support section 7 (step S22). Since the cold-stored medicine substituted by dummy body 5a is held in cold-storage container 33a, medicine information and storage information of management information of cold-storage container 33a are displayed on display section 22 of exchange support section 7 (step S23). At this time, on display section 22 of exchange support section 7, the following message shown in FIG. 11 is displayed.

FIG. 11 is a front view showing display section 22 of exchange support section 7 in medicine selection support system 31 in accordance with the second embodiment of the invention. Display section 22 displays managed medicine information indicating that “Exchange with cold-stored medicine A. Cold-stored medicine A is contained in cold-storage container A.”

When the medicine information of dummy body 5a indicates cold-stored medicine A, according to the managed medicine information displayed on display section 22 in FIG. 11, cold-stored medicine A is taken out from cold-storage container 33a, and then dummy body 5a is exchanged with cold-stored medicine A.

When exchange between dummy body 5a and cold-stored medicine A is completed, an operator presses exchange completion button 23 of exchange support section 7. Then, exchange support section 7 detects that exchange completion button 23 is pressed (step S24), and transmits exchange completion information to medicine information management device 3 (step S25). At this time, exchange support section 7 wirelessly communicates with wireless receiving section 24, so that exchange completion information is transmitted from wireless receiving section 24 to medicine information management device 3 via wired network 25. Note here that the exchange completion information includes operator information of an operator who carried out exchange, in addition to information of exchanged medicines.

FIG. 12 shows management table 35 of the identification number of each of dummy bodies 5a and 5b in medicine selection support system 31 in accordance with the second embodiment of the invention. In medicine information management device 3, as shown in FIG. 12, information such as the time when exchange between dummy bodies 5a and 5b and managed medicines is completed, operator information, and storages of managed medicines, is recorded.

Furthermore, when dummy body 5b is detected by exchange support section 7, a caution medicine held in security container 33b and dummy body 5b are exchanged with each other by the same procedure immediately before medicines are administered to a patient.

In this way, in medicine selection support system 31 using dummy bodies 5a and 5b, by using cold-storage container 33a and security container 33b, which are movable storages, dummy bodies 5a and 5b can be exchanged even in a room that is not provided with cold storage 32a and security storage 32b.

Note here that since security container 33b is movable, security container 33b itself may be lost. Therefore, it is more safely that security container 33b is brought to room 40 immediately before the timing when medicines are administered to a patient.

Furthermore, transferring of cold-stored medicines from cold storage 32a to cold-storage container 33a, and transferring of caution medicines from security storage 32b to security container 33b are not necessarily carried out by human's hand. Medicines may be dispensed automatically from cold storage 32a and security storage 32b by simply inputting moving destination information.

Furthermore, a plurality of trays 4 that have undergone formal inspection may not be placed on wagon 8 and transported to room 40 as an exchange place at one time. Only one tray 4 and cold-storage container 33a and security container 33b, which store only management medicines that are to be exchanged with dummy bodies 5a and 5b on tray 4, may be moved to room 40.

In this way, when automatic dispensing device 2 dispenses dummy body 5a to tray 4, a management table of FIG. 12 is additionally formed on medicine information management device 3 in which an identification number of dummy body 5a and substitute managed medicines are associated with each other (for example, the first line left three items in a management table of FIG. 12). The managed medicine itself corresponding to dummy body 5a (for example, cold-stored medicine A) is taken out from cold storage 32a by an operator and transferred to cold-storage container 33a. At this time, the operator inputs a management number of cold-storage container 33a into input/output section 34a of cold storage 32a, and medicine information management device 3 allows management number of cold-storage container 33a as a storage to correspond to identification numbers of dummy body 5a in a management table (for example, the first line right item in a management table of FIG. 12). Tray 4 and cold-storage container 33a are transported to room 40 as a transport destination by a transporting person. When the time of medicine administration to a patient approaches, operator A registers as an operator by allowing an operator's card to approach detection section 21 of exchange support section 7. Operator A allows detection section 21 of exchange support section 7 to approach dummy body 5a and detects tag information (medicine information and identification number) from RFID tag 12 of dummy body 5a. Exchange support section 7 inquires medicine information management device 3 and gains a management number of the storage that holds managed medicines (for example, cold-stored medicine A) indicated by tag information of dummy body 5a from a management table of medicine information management device 3. Exchange support section 7 displays the gained storage information and medicine information on display section 22 (for example, cold-storage container 33a and cold-stored medicine A are displayed). When exchange between dummy body 5a and cold-stored medicine A is completed, an operator presses exchange completion button 23 of exchange support section 7. Thus, exchange support section 7 sends exchange completion information to medicine information management device 3. Medicine information management device 3 records a person who carried out exchange and exchanging time (for example, operator A and 13:00) in a corresponding portions in the management table based on the exchange completion information. Dummy body 5a that was exchanged is temporarily contained in a collection place and transported from the collecting place by a collecting and transporting person, and put into a dummy body dispensing section of automatic dispensing device 2. Note here that a dummy body may not necessarily have an RFID tag, a dummy body may have identification number by a bar code. At this time, management information formed in medicine information management device 3 corresponding to identification number of a dummy body corresponds to medicine information recorded in the dummy body. Needless to say, a prescription number, patient information, and the like, corresponding to the identification number of the dummy body may be included in a management table.

### THIRD EMBODIMENT

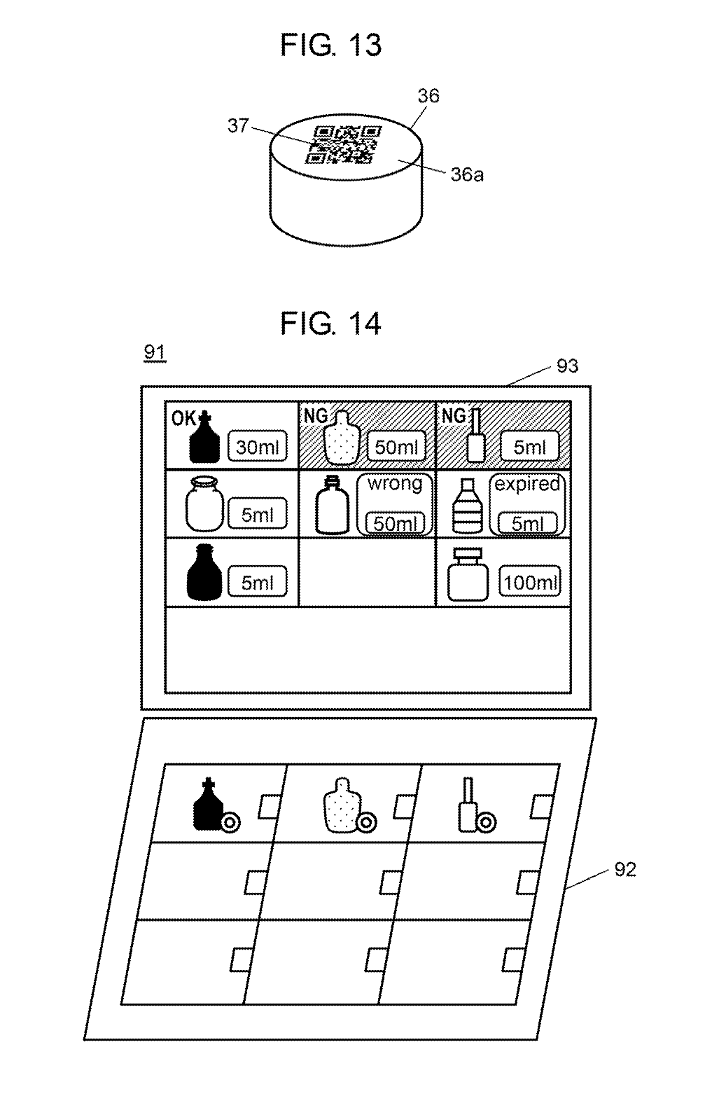

FIG. 13 is a perspective view showing dummy body 36 in accordance with a third embodiment of the invention. As shown in FIG. 13, dummy body 36 of the third embodiment records medicine information recorded in dummy body 36 in a two-dimensional bar code not in an RFID tag described in the first and second embodiments. The medicine selection support system can exchange managed medicine with dummy body 36 by using the two-dimensional bar code.

That is to say, a medicine selection system of the third embodiment is the same as those in the first and second embodiments except that medicine information is recorded not in an RFID tag in dummy body 36 but in a two-dimensional bar code on surface 36a of dummy body 36.

Firstly, general medicines and dummy body 36 are dispensed from automatic dispensing device 2 to tray 4 according to medicine information. At this time, in dummy body 36, medicine information of the managed medicine is converted into the two-dimensional bar code and the bar code is printed on surface 36a of dummy body 36.

FIG. 13 shows dummy body 36 that records two-dimensional bar code 37.

After two-dimensional bar code 37 is printed on surface 36a of dummy body 36, formal inspection by an inspector is carried out in a state in which dummy body 36 is included. Thereafter, as shown in FIG. 1, a plurality of trays 4 are placed on wagon 8 which are transported to room 20. When the time of medicine administration to a patient approaches, an operator such as a nurse and a pharmacist exchanges dummy body 36 on tray 4 with a managed medicine by using exchange support section 7.

At this time, detection section 21 of exchange support section 7 reads out medicine information by two-dimensional bar code 37. Herein, detection section 21 has an image pickup device for reading out two-dimensional bar code 37. The medicine information, which is read out by the image pick-up device, is displayed on display section 22. In the third embodiment, the medicine information displayed on display section 22 is used for exchange between dummy body 36 and a managed medicine. Thus, dummy body 36 using two-dimensional bar code 37 is exchanged with a managed medicine.

In the above-mentioned description, a variety of embodiments are described. Needless to say, systems made by. appropriately combining these embodiments by a person skilled in the art are encompassed in the invention.

In a medicine selection support system according to the invention, dummy bodies as managed medicines can be selected at the same timing as that of general medicines, and the occurrence of forgetting or mistaking in selecting managed medicines can be significantly reduced, and therefore, the medicine selection support system can be greatly used in, for example, hospitals and is useful.

### REFERENCE MARKS IN THE DRAWINGS

1, 31 medicine selection support system

2 automatic dispensing device

2a dispensing section

2b recording section

2c, 7a dummy body detector

2d, 19, 53, 56, 63 display section

3 medicine information management device

4 tray

5a, 5b, 36, 50, 50a, 50b, 55, 60 dummy body

6a, 32a cold storage

6b, 32b security storage

6c RFID detector

7 exchange support section

7b exchange completion information transmitting section

8 wagon

9 exchange support section

10 general medicine

11 bar code

12 RFID tag

13a, 13b, 13c area

14, 34a, 34b input/output section

16 medicine dispensing section

17 dummy body dispensing section

18 medicine information writing section

20, 40 room

detection section

22 display section

23 exchange completion button

24 wireless receiving section

25 wired network

32a cold storage

32b security storage

33a cold-storage container (mobile storage)

33b security container (mobile storage)

35 management table

36a; 52a, 61a surface

37 two-dimensional bar code

51, 62 memory section

52, 61 dummy body main body

56a, 56b, 56c divided areas

54 light-emitting element

65 dummy body storage section

66 medicine storage section

1. A medicine selection support system, comprising:
a dummy body selected based on pharmacy information;
a dummy body detector for detecting medicine information from the dummy body; and
an exchange support section for supporting exchange between a medicine and the dummy body based on the medicine information detected by the dummy body detector.

2. The medicine selection support system of claim 1,
wherein the dummy body is dispensed as a managed medicine dummy together with a general medicine by an automatic medicine dispensing device.

3. The medicine selection support system of claim 2,
further comprising a medicine information management device for recording information that the automatic dispensing device dispenses the dummy body, and information that the dummy body and the managed medicine are exchanged with each other;
wherein the dummy body detector includes an exchange completion information transmitting section for transmitting detected exchange completion information indicating that the dummy body is exchanged with the managed medicine to the medicine information management device.

4. The medicine selection support system of claim 2,
further comprising the automatic dispensing device for dispensing the general medicine and the dummy body based on the pharmacy information,
wherein the automatic dispensing device comprises at least any of a dispensing section for dispensing the managed medicine, a recording section for recording at least medicine information of the managed medicine in the pharmacy information into the dummy body, and the dummy body detector for detecting medicine information from the dummy body.

5. The medicine selection support system of claim 1 4,
wherein the dummy body detector has a deleting function for deleting the medicine information recorded in the dummy body.

6. The medicine selection support system of claim 1,
wherein the dummy body has an RFID tag in which the medicine information is recorded.

7. The medicine selection support system of claim 1,
wherein the dummy body has an attaching section to which a seal is attached, and the seal is color-coded based on the medicine information.

8. The medicine selection support system of claim 1,
wherein the dummy body has an attaching section to which a seal is attached, and the seal includes a medicine name printed thereon based on the medicine information.

9. The medicine selection support system of claim 1,
further comprising an automatic dispensing device for dispensing a general medicine and a dummy body based on a managed medicine according to pharmacy information,
a mobile storage that holds the managed medicine; and
a display section for displaying storage information of the mobile storage from which the managed medicine is dispensed from the medicine information.

10. The medicine selection support system of claim 9,
wherein the managed medicine is a cold-stored medicine that requires temperature management, and the mobile storage is a cold-storage container capable of carrying out temperature management.

11. The medicine selection support system of claim 9,
wherein the managed medicine is a deleterious substance that requires security management, and the mobile storage is a security container capable of carrying out security management.

12. A medicine selection support method comprising:
automatically dispensing a general medicine and a dummy body that is a managed medicine dummy to a transporting container based on pharmacy information, and
exchange-supporting for supporting exchange between the dummy body and the managed medicine based on medicine information detected from the dummy body by a dummy body detector.

13. The medicine selection support method of claim 12,
wherein in the exchange-supporting,
when the medicine information is detected by the dummy body, storage information of a mobile storage for holding the dummy body is displayed.

14. A medicine dispensing device, comprising:
an internal dummy body;
an input/output section for inputting/outputting pharmacy information including prescription information,
a medicine dispensing section for selecting a medicine held therein, based on the pharmacy information;
a dummy body dispensing section for selecting the dummy body as a substitute for a medicine that is not held in the medicine dispensing section, based on the pharmacy information; and
an exchange support section for writing medicine information of the substitute into the dummy body based on the pharmacy information.

15. A dummy body comprising:
a memory section for recording at least medicine information and transmitting the medicine information;
a dummy body main body having a three-dimensional shape; and
an exchange support section including a display section on which at least a part of the medicine information stored in the memory section is displayed on a surface of the three-dimensional shape.

16. The dummy body of claim 15,
wherein the display section carries out display by varying colors corresponding to the medicine information.

17. The dummy body of claim 15,
wherein the display section has a divided area that is divided into a plurality of areas, and displays a different divided area corresponding to the medicine information.

18. The dummy body of claim 15,
wherein the dummy body main body further comprises a speaker.
